(19) United States
(12) Patent Application Publication
(10) Pub. No.: US 2007/0190273 A1
(43) Pub. Date: Aug. 16, 2007

(54) CARBONACEOUS HOLLOW MOLDED ARTICLE AND FABRICATION METHOD THEREOF

(75) Inventor: Maki HAMAGUCHI, Kobe-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Kabushiki Kaisha Kobe Seiko Sho (Kobe Steel, Ltd), Kobe-shi (JP)

(21) Appl. No.: 11/567,984

(22) Filed: Dec. 7, 2006

(30) Foreign Application Priority Data
Feb. 10, 2006 (JP) 2006-034340

(51) Int. Cl. B28B 11/00

(52) U.S. Cl. 428/34.4

(57) ABSTRACT

Disclosed is a seamless central diameter expanded hollow molded articles made only of glasslike carbon. A fabrication method of the seamless carbonaceous hollow molded article having an expanded core includes: a cast-molding process, in which a liquid thermosetting resin is poured into a cavity formed between a core and an outer body made of a thermally fusible (or hot meltable) material, and a seamless thermosetting resin molded article having an expanded core is formed in hollow shape; a core flowing out process, in which the thermally fusible material of the cast molded core melts by heating and flows out; and a carbonization process, in which the thermosetting resin molded article is carbonized.

### BACKGROUND OF THE INVENTION

1. Field of the Invention

The present invention relates to a novel seamless carbonaceous hollow molded article that is made only of glasslike carbon having a hollow shape whose core is expanded, and a fabrication method thereof. This carbonaceous hollow molded article can be utilized, for example, for filling agents or heat transfer mediums used under high-temperature, corrosive environment, heating elements used for dielectric heating etc., and further various containers or reactors having heat resistance/corrosion resistance.

2. Description of the Related Art

Glasslike carbon is a substance that is obtained by heating and carbonizing a thermosetting resin such as a phenol base resin at a high temperature under nonoxidizing atmosphere. The glasslike carbon has chemically stable properties since it is carbon but is not readily crystallized like graphite, and has a very small amount of impurities. Thus, it is widely used in various fields as a component for using under high temperature or highly corrosive environment. Such a glasslike carbon product typically takes a plate shape, cylindrical (pipe) shape, or cup shape (crucible, etc.).

Meanwhile, for filling agents or heat transfer mediums used in a high temperature/corrosive environment, heating elements or reactors used for dielectric heating, hollow spherical shaped ceramics or glass parts are used. Even though it is believed that glasslike carbon may exert excellent properties in these applications, in reality carbonaceous hollow molded articles are rarely used. The biggest reason seems to be that it is difficult to manufacture a hollow molded article made of glasslike carbon.

Even though there are several factors that make the manufacture more difficult, the gas formation resulted from thermal decomposition when a thermosetting resin, a precursor of glasslike carbon, is carbonized is the biggest reason why it is difficult to obtain a glasslike carbon molded article with a thickness of 5 mm or more. As an alternative, one may think of fabricating a large glasslike carbon molded article first and then emptying the inside to finish it as a hollow molded article. However, this is an unrealistic plan from the viewpoint of industrial yield.

Another alternative is processing glasslike carbon to a half-spherical shape (bowl shape) and joining two of them into one, thereby fabricating a hollow spherical body. However, because glasslike carbon is chemically inactive, it is not easy to get a desirable mechanical strength and in many cases the heat resistance or the corrosion resistance at the seam tends to be somewhat deteriorated.

Still some believed that they could obtain a glasslike carbonaceous hollow molded article without any seam defects by preparing a half-spherical molded article from a thermosetting resin that is a precursor, joining two of them together to get a hollow spherical body, and then carbonizing. For instance, a half-spherical molded article (bowl shape) is made of a thermosetting resin, and two of them are joined together as one body to form a hollow spherical body. Lastly, the hollow spherical body is subjected to a carbonization process. However, this method has a poor productivity because two processes have to be performed. Moreover, the above-described method poses other problems that: it is not easy to obtain sufficiently good size accuracy and the same level of mechanical strength with that of the main body; and that cracks are easily formed from the joining part.

Meanwhile, the applicants of the invention suggest the technology of a glasslike carbon pipe and its fabrication method disclosed in Japanese Patent Laid-Open No. H11-322428. According to the cited invention, the production method of a glasslike carbon pipe comprises the steps of: using a rod made of a thermally fusible material and molded in an interior shape of a pipe as a core; filling the circumference of the core with a thermosetting resin material powder; heating the core to a temperature below the melting point of the thermally fusible material forming the core to cure the material thereof; heating the core above the melting point of the thermally fusible material to cause the melting and flowing out of the core; and carbonizing the resulted thermosetting resin pipe to form the glasslike carbon pipe. This method is useful for forming a glasslike carbon pipe without seams.

However, when the inventors tried to manufacture a seamless hollow molded article (typically, a hollow sphere molded article) based on the above technology, the following problems occurred. One of them is that in order to obtain a hollow sphere molded article with a thermosetting resin material as a precursor of the glasslike carbon hollow spherical body, the sphere core, without contacting a corresponding outer body, should be securely fixed in the same core shape to the inside of the outer body having an inner circumferential wall inside the sphere, so that it may not move when the resin powder is filled and cured. However, this task is rather difficult to positively perform industrially, and with a high level of reproducibility. Even though the core may be fixed accurately within the outer body, during the process of the thermosetting resin being completely cured, the molded article sometimes cracked due to curing shrinkage, and a hollow spherical body having a desired size and shape was hard to obtain.

In short, although the technology proposed in Japanese Patent Laid-Open No. H11-322428 is useful for fabricating a glasslike carbon molded article without seams, it cannot be used for fabricating a seamless glasslike carbonaceous hollow spherical body, and further researches are needed. In addition, to the knowledge of the inventors, Japanese Patent Laid-Open No. H11-322428 did not show any example of fabricating a glasslike carbonaceous hollow sphere molded article without seams.

### SUMMARY OF THE INVENTION

It is, therefore, an object of the present invention to provide to a novel seamless glasslike carbonaceous hollow sphere molded article and a fabrication method thereof.

To achieve the above objects and advantages, there is provided a seamless carbonaceous hollow molded article made only of glasslike carbon having a hollow shape with an expanded core.

Another aspect of the present invention provides a suitable method for fabricating the carbonaceous hollow molded article, the method comprising: a cast-molding process in which a liquid thermosetting resin is poured into a cavity formed between a mold and a core which is placed inside of the mold and is made of a thermally fusible (or hot meltable) material, and a seamless thermosetting resin molded article having an expanded core is formed in hollow shape; a core flowing out process, in which the thermally fusible core is melted by heating and is made to flow out; and a carbonization process, in which the thermosetting resin molded article is carbonized.

Upon performing the fabrication process, it is preferable that the core is made of a thermally fusible material having a softening point between 70° C. and 200° C., so that the flowing out of the core in the cast-molding process can be done more efficiently, and a carbonaceous hollow molded article stable in size and quality can be manufactured at a high efficiency.

In the cast-molding process, a spacer may be used to secure the position of the core inside of the mold. The spacer is preferably made of the same thermosetting resin as the starting material of the product. This enables the spacer to be incorporated into the molded resin body upon heating and to be carbonized to constitute a part of the product. In this manner, a hollow molded article of a desired thickness as designed can be manufactured more conveniently.

As described above, the inventive carbonaceous hollow molded article is made only of glasslike carbon, and is a seamless molded article having an expanded core in a hollow shape. It features high size accuracy, and excellent mechanical strength without a weak point, so that problems like leakage of content or occurrence of dust particles from the seam are eliminated. Accordingly, taking full advantage of the glasslike carbon's natural properties, i.e., excellent heat resistance, corrosion resistance, heat transfer, and conductivity, the carbonaceous hollow molded article of the invention can widely be utilized for filling agents that can endure high temperature/highly corrosive environments, heat transfer/heating mediums and further high-temperature reactors. Moreover, according to the fabrication method of the invention, a hollow molded article made of grasslike carbon having such configuration characteristics can easily, stably and efficiently be formed from the industrial perspective.

Additional and/or other aspects and advantages of the present invention will be set forth in part in the description which follows and, in part, will be obvious from the description, or may be learned by practice of the invention.

### BRIEF DESCRIPTION OF THE DRAWINGS

The above aspects and features of the present invention will be more apparent by describing certain embodiments of the present invention with reference to the accompanying drawings, in which:

FIG. 1 is a flow chart explaining a fabrication method of the present invention; and

FIG. 2 is an explanatory cross-sectional view showing an example of a spacer and arrangement thereof in accordance with a preferred embodiment of the present invention.

### DETAILED DESCRIPTION OF THE PREFERRED EMBODIMENTS

A preferred embodiment of the present invention will be described herein below with reference to the accompanying drawings.

In the invention, a hollow molded article having a core hollow portion with its central portion expanded should be regarded as a hollow molded article of which inner diameter of the central portion is larger than that of the bottom or the top portions, and in those using a specific shaped core during molding, the term means a hollow molded article having a shape in which the central portion is undercut so that the core cannot be ejected. One of the most typical shapes that meet the description is a hollow spherical body. However, the invention is not limited thereto, and an oval body, a spheroid body, a spherical shell body, a container having at least one opening formed on the top or on the lateral wall, and a reactor are also included. In the following specification, these hollow molded articles may be referred to as “central diameter expanded hollow molded articles”.

Because such a central diameter expanded hollow molded article has an undercut portion on the inside, the core cannot easily be ejected and be molded to one body by adopting the conventional technologies. This is why plural pieces (such as, two) of molds are formed as explained before, and joined later as one hollow molded article. However, this method including the joining operation not only complicated the process overall, but also posed other problems such as low yield, poor size accuracy, and seam defects leading to product defects. In practice, no one has yet proposed a seamless, central diameter expanded hollow molded article made only of glasslike carbon.

However, the inventors discovered that when a hollow molded article was formed from a thermosetting resin that is a precursor of glasslike carbon, even a core having an undercut portion inside was easily ejected (released) from the inside of the molded article, by using a selected core material and a resin with appropriate properties described below. And as a result, a seamless central diameter expanded hollow molded article consisting of a thermosetting resin could be obtained. Moreover, the inventors discovered that the seamless central-diameter-expanded hollow article made of glasslike carbon could be obtained even more easily by performing a commonly known carbonization process on the hollow molded resin article.

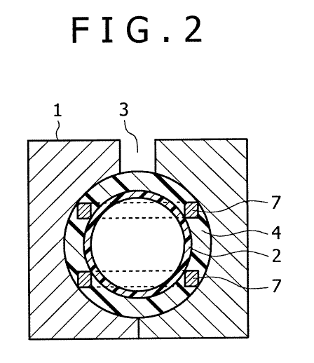

Referring again to Japanese Patent Laid-Open No. H11-322428, it disclosed a method for producing a pipe using a rod made of a thermally fusible material as a core. However, the pipe thus formed does not have an undercut portion therein, and from the beginning the cited invention was not directed to the manufacture of a central diameter expanded hollow molded article as in the present invention. As evident from the text description of Japanese Patent Laid-Open No. H11-322428 and the exemplary embodiment shown in FIG. 2, a pipe is the single product obtained and only a rod-like object was indicated as a core of the pipe.

Accordingly, the first invention of the inventors is a novel seamless central diameter expanded hollow molded article made only of glasslike carbon that has never been fabricated by any known technologies including the technology disclosed in Japanese Patent Laid-Open No. H11-322428, and the second invention of the inventors is a method for fabricating such a seamless central diameter expanded hollow molded article at high efficiency from the industrial perspective.

That is to say, the inventive central diameter expanded hollow molded article is made only of glasslike carbon and is one seamless molded article despite an undercut portion existing inside. Although a hollow spherical body is the most typical example for its shape, an oval body, a spheroid body having a vertically or laterally extended hollow, a spherical shell body, a crucible type container or reactor having a reduced diameter on the top, or a piece variant tubing having an opening with a reduced diameter in a vertical direction can also be used, each of which may have one or more than two openings formed in the outer cover. As mentioned before, these central diameter expanded hollow molded articles may be benefited from the natural properties of glasslike carbon when incorporated with filling agents or heat transfer mediums exposed to high temperature/highly corrosive environments, heating elements using ultrasonic waves or high frequency waves, and further, heat resistant containers or heat resistant/corrosion resistance reactors.

Moreover, the fabrication method of the invention is effective for fabricating the central diameter expanded hollow molded article. Basically, by forming the core with a thermally fusible material, it becomes possible to make the core serve to form the inner surface of the molded article at a point where a thermosetting resin which is a precursor of glasslike carbon is molded and cured. Meanwhile, during a curing process, the core melts and flows out of the molded article so that although an undercut portion may exist inside the molded article, the core can easily be released (flow out) without much difficulty, consequently yielding a seamless central diameter expanded hollow molded article.

Desirably, the thermally fusible material used for the core has a softening point not lower than 70° C. and not greater than 200° C. More desirably, the softening point of the thermally fusible material of the core is not lower than 90° C. and not higher than 150° C.

Incidentally, thermosetting resins used as a precursor of glasslike carbon have various curing initiating temperatures. In most cases the initiation temperature for thermosetting is usually about 60° C. or higher. Thus, if the softening point of a material of the core is lower than 70° C., the core may be deformed during the cast-molding process and might lose its function over the inner surface. A more common curing temperature for a thermosetting resin in cast-molding is about 80° C. or higher. Therefore, more preferably, a core material having a softening temperature of not lower than 90° C. is used. In cast-molding, if the core material is heated rapidly to a temperature higher than 100° C., bubbles may be produced inside the molded article or cracks may be formed. Therefore, in general, after a liquid resin is poured to a cavity at room temperature, the temperature should be slowly increased and a curing process should proceed slowly.

Meanwhile, a desirable softening temperature of the core material is about 200° C. or below. Incidentally, in a typical fabrication procedure of glasslike carbon, before the thermosetting molded article is carbonized, it is heated to about 200° C. under inert gas atmosphere or in the air to completely cure the resin (this is generally called “curing”). Also, in order to make sure that the core melts and flows out of the molded article in the curing process, the softening temperature of the core material is preferably 200° C. or below.

In addition, since the thermosetting resin is considerably shrunk during the curing process, if the shrinkage progresses before the core melts, the thermosetting resin molded article may be broken or cracked. Therefore, to avoid such problems, the melting process should be initiated before the resin molded article is completely cured and shrunk. To this end, the softening temperature of the core material is preferably 180° C. or below, and more preferably 160° C. or below.

Examples of core materials that meet the above-described conditions are described below. For example, there are thermoplastic resins such as polystyrene, polyethylene and polypropylene, or solid paraffin (so called “wax”), and low melting point metals (solder alloys, etc.). In particular, polystyrene and polyethylene are desired among them because they are low in price and do not leave residuals inside the glasslike carbon molded article as an end product.

In addition, the core is desirably hollow. This is because such a core can also shrink when the thermosetting resin molded article undergoes curing and shrinking, and hopefully relieves stress (tensile stress) on the molded article.

As a starting material for glasslike carbon, liquid thermosetting resins are used. Examples of such resins include phenol resins, furan resins, epoxy resins and the like, but phenol resins are preferred among them from the viewpoint of strength of glasslike carbon or carbon yield. As for the phenol resins, both of a resol type or a novolac type, may be used. Depending on use, part of the phenol may be substituted with cresol, xylenol, naphthol, etc.

The liquid thermosetting resin used in the invention preferably has mold shrinkage during curing of 3% or less, and more preferably below 2%. In other words, when the mold shrinkage exceeds 3%, although dependent on the kind of core used, there is the possibility that the molded article may be cracked due to shrinkage of the thermosetting resin before the core is softened and melted. There is no lower limit to the mold shrinkage because when the mold shrinkage is lower, it is more difficult for cracks to be formed during molding.

In addition, the mold shrinkage in the invention is defined as follows. That is, a liquid thermosetting resin was filled in a stainless steel mold having a rectangular slot (mold size: 10 mm wide×10 mm deep×100 mm high) to about 5 mm in depth, maintained at 80° C. for 72 hours to cure the thermosetting resin, and cooled to room temperature to be released from the molded article. Here, a rate of change obtained from the following equation in terms of length of the molded article (L₂) and length of the mold (L₁: 100 mm) is designated as mold shrinkage.

Rate of change=(L₁−L₂)/L₁×100(%)

Any of commercially available resins can be selectively used as the liquid thermosetting resin provided that the mold shrinkage thereof meets the above condition. In addition, if a commercially available resin has too high of a mold shrinkage, it is possible to adjust the mold shrinkage by (1) heating and thus expediting the curing process; (2) heating in the presence of a catalyst and thus expediting the curing process; or (3) removing a diluting element such as water or solvent contained in the liquid resin.

The molding of a liquid resin is performed by cast molding. In this method, a liquid resin is poured into a predetermined shape mold, and cured by means of heating or UV irradiation. The cast-molding method is selected because a core is less susceptible to deformation, as a resin material is easily filled in absence of pressure, and because the method is appropriate for molding a core made of a thermally fusible material. In other words, the core is deformed in press molding that accompanies compression.

In addition, there is no limitation for the method to keep the core made of a thermally fusible material inside the mold, and any of well-known methods may be used. For example, a device or means which suspend the core to an opening of the molded article may be used. However, the following method is very effective in view of improving yield or quality. A core having a smaller diameter than that of an outer body (mold) of a splittable structure is kept in the inner hollow at a space which is equal to the thickness of the molded article with aid of a spacer that has the same thickness as the space. Desirably, the spacer is a curing molded article made of the same material as the liquid thermosetting resin. Although there is no limitation for the shape of the spacer, in general, a ring shape, a rectangular shape, a donut shape and the like may be used.

In the cast-molding process, the spacer made of cured thermosetting resin can be formed into the body of the cast-molded article. Therefore, the spacer is not necessarily removed, but is converted into a part of the cast-molded article. Through the carbonization process next, the spacer, together with the cast-molding material, is changed to glasslike carbon.

Following the cast-molding process, the molded article is ejected from the mold, and a drawing hole is perforated at a suitable position of the molded article. Then, the molded article is turned upside down and heated at a temperature above the melting point of the core material to cause the melting and flowing out of the core, whereby a central diameter expanded hollow molded article made of a thermosetting resin material as a precursor of glasslike carbon can be obtained. Lastly, the resulted molded article is carbonized by a well-known carbonization method to produce a seamless central diameter expanded hollow molded article made only of glasslike carbon. Although there is no limit to the carbonization condition, heat treatment that is performed at a high temperature of 1000° C. or above, i.e., 1000 to 2500° C. in general, under inert gas atmosphere.

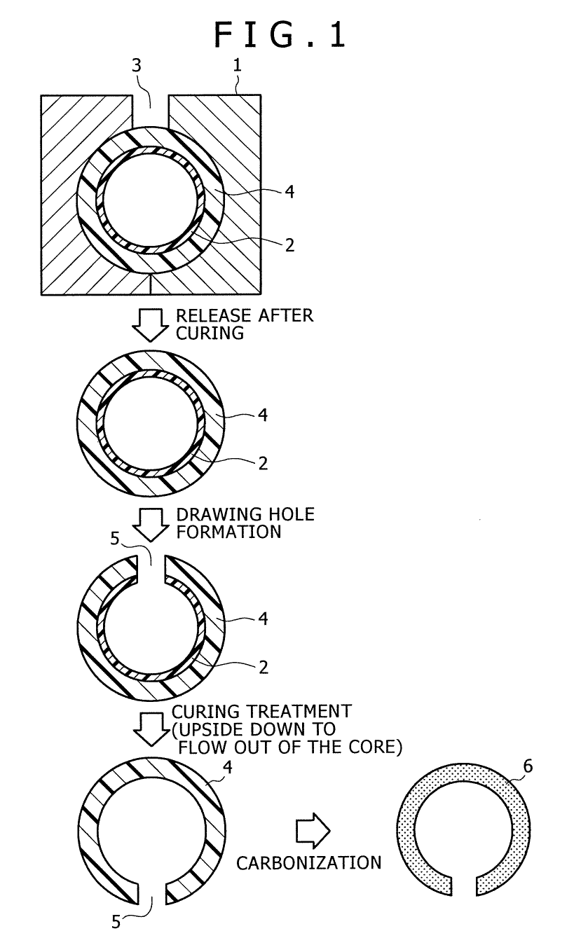

FIG. 1 is a flow chart explaining a typical process employed in the invention. A hollow core 2 made of a thermally fusible material is fixed through a spacer (not shown) on the inside of a mold 1 with a splittable structure into two. Then, a liquid thermosetting resin is poured through an injection hole 3 located at the top of the mold into a space (cavity) that is formed between the mold 1 and the core 2. The mold 1 was heated to a predetermined temperature in order to cure the thermosetting resin. When the thermosetting resin is cured, a thermosetting resin molded article 4 together with the core 2 is separated from the mold 1. Next, a drawing hole 5 is perforated at an appropriate position on the molded article 4, and the molded article 4 is heated above the softening/fluidizing temperature of the core material, the drawing hole 5 being at the bottom during heating, to cause the core 2 to melt and flow out and to cure the molded article 4 at the same time. Finally, the thermosetting resin molded article thus obtained is heated and carbonized under inert gas atmosphere, and a final product of the invention, i.e., a seamless central diameter expanded hollow molded article 6 made only of glasslike carbon is obtained.

FIG. 2 is an explanatory cross-sectional view showing an example of the spacer involved in position-securing of the core. As shown in the drawing, with aid of two ring-shaped spacers 7 made of a thermosetting resin, the hollow core 2 is placed at the inner central portion of the mold 1. In this structure, the spacers 7 are completely incorporated into the body of the glasslike carbon product through curing and carbonizing treatment.

### EXAMPLES

The following preferred examples are illustrative of the present invention and are not to be construed as limitative in any way.

### Experimental Examples

Based on the flow chart shown in FIG. 1, molding experiments were performed as follows.

As for a mold, a stainless steel mold (splittable into two) having a spherical cavity with an inner diameter of 30 mm and a resin injection hole with a diameter of 11 mm formed in the top is used. As for the core, a hollow sphere having an exterior diameter of 25 mm and a thickness of 1 mm and being made of various materials listed in Table 1 is used. The core is then fixed inside the stainless steel mold by core matching by means of spacers (to be described) (ring-shaped, thickness: 2.5 mm, outer diameter: 10 mm, and inner diameter: 6 mm) made of a phenol resin.

A liquid thermosetting resin as a starting material is prepared as follows. A commercially available liquid phenol resin No. PL-4804 (GUN EI Chemical Industry Co., LTD) and 0.1 mass % of hexamethylenetetramine as a catalyst were subjected to a preliminary curing reaction at 65° C. to alter the mold shrinkage rate of the resin. Thus prepared liquid resin material was used for cast molding.

The liquid resin material is poured into a cavity between the stainless steel mold and the core, heated at 70° C. for 48 hours to be thermally cured, and released with the core from the mold.

Next, a drawing hole having a 5 mm diameter is perforated into the resulted spherical phenol resin molded article, and heated at 200° C. for 10 hours, the molded article being upside down for heating, to cause a thermally fusible material of the core to melt and flow outside and at the same time, cure the phenol resin inside the cavity. As such, all of the thermally fusible material of the core is melted and flown out by heating, and a hollow sphere phenol resin molded article is obtained.

Experiments were performed based on the above-described method with variations in conditions including the kind of thermally fusible material of the core, softening point of the same, curing time of the phenol resin and so on. The results are summarized in Table 1.

### Example 1

Polystyrene (Acros Organics Co., Product No. 17889-1A) with a softening point of about 110° C. was used as the core material, and the same condition was applied except that the curing time of the phenol resin was set to 1 hour. The mold shrinkage of the phenol resin used for the experiment was 5.5%, and because of this high mold shrinkage, cracks were generated in the resulted cast-molded article.

### Example 2

Polystyrene (the same as in Example 1) with a softening point of about 110° C. was used as the core material, and the same condition was applied, except that the curing time of the phenol resin was set to 2 hours. The mold shrinkage of the phenol resin used for the experiment was 3.5%, and because of this high mold shrinkage, cracks were generated in the cast-molded article during a curing process.

### Example 3

Polystyrene (the same as above) with a softening point of about 110° C. was used as the core material, and the same condition was applied except that the curing time of the phenol resin was set to 2.5 hours. The mold shrinkage of the phenol resin used for the experiment was 2.9%, and no cracks were observed in the cast-molded article and the cured article.

### Example 4

Polystyrene (the same as above) with a softening point of about 110° C. was used as the core material, and the same condition was applied except that the curing time of the phenol resin was set to 3 hours. The mold shrinkage of the phenol resin used for the experiment was 1.9%, and no cracks were observed in the cast-molded article and the cured article.

### Example 5

The same condition as the Example 4 was used, except that solid paraffin (Kanto Chemical Co., INC. Product No. 32513-02) with a softening point of 68-70° C. was used as the core material, and other than that, the same condition as above was applied. The mold shrinkage of the phenol resin used for the experiment was 1.9%, and no cracks were observed in the cast-molded article and the cured article.

### Example 6

The same condition as the Example 4 was used, except that solid paraffin (Kanto Chemical Co., INC. Product No. 32511-02) with a softening point of 64-66° C. was used as the core material. Because the softening point of the resin used for structuring the core was too low, and the core was deformed during the cast-molding process, a hollow molded article having a desired inner surface was not obtained.

### Example 7

The same condition as the Example 4 was used, except that polyethylene (Acros Organics Co., Product No. 17850-1A) with a softening point of 130-145° C. was used as the core material. As a result, no cracks were observed in the phenol resin molded article and the cured article.

### Example 8

The same condition as the Example 7 was used, except that polycarbonate (Acros Organics Co., Product No. 17831-1A) with a softening point of about 190° C. was used as the core material. As a result, no cracks were observed in the phenol resin molded article and the cured article.

### Example 9

The same condition as the Example 8 was used, except that nylon-66 (Acros Organics Co., Product No. 17792-1A) with a softening point of about 220° C. was used as the core material. Possibly, because the softening point of the core was too high, cracks were formed in the molded article before the core was melted and flown out in the curing process of the phenol resin molded article.

[Fabrication of Glasslike Carbonaceous Hollow Sphere Molded Article]

The curing articles obtained from the Experiments 4, 5, 7, and 8 were put in an electric furnace, and carbonized by heat treating at 100° C. for five hours under nitrogen gas atmosphere. Products thus obtained were seamless hollow sphere glasslike carbon molded articles, each having an outer diameter of 25 mm and a thickness of 2 mm without defects such as cracks.

TABLE 1

| | Phenol Resin | | Thermally Fusible | | | |
|---|---|---|---|---|---|---|
| | Curing | Mold | | Softening | | |
| Experiment | Time | Shrinkage | | Point | | In |
| No. | (h) | (%) | Material | (° C.) | In molding | curing |
| 1 | 1 | 5.5 | Polystyrene | About 110 | Cracks | — |
| 2 | 2 | 3.5 | Polystyrene | About 110 | Good | Cracks |
| 3 | 2.5 | 2.9 | Polystyrene | About 110 | Good | Good |
| 4 | 3 | 1.9 | Polystyrene | About 110 | Good | Good |
| 5 | 3 | 1.9 | Solid paraffin | 68–70 | Good | Good |
| 6 | 3 | 1.9 | Solid paraffin | 64–66 | Core was deformed | — |
| 7 | 3 | 1.9 | Polyethylene | 130–145 | Good | Good |
| 8 | 3 | 1.9 | Polycarbonate | About 190 | Good | Good |
| 9 | 3 | 1.9 | Nylon-66 | About 220 | Good | Cracks |

### Example 10

A 2 mm-thick plate was formed from the same phenol resin used in the Example 4, and a ring shaped molded article (outer diameter: 24 mm, inner diameter: 21 mm, and thickness: 2 mm) used as a spacer was cut out from the plate. In addition, the spacer has a cavity in a portion of the inner and outer circumference, to be used as a passage for pouring a resin for casting.

Using the same polystyrene hollow core (thickness: 1 mm) with the softening point of about 110° C. used in the Example 4 and using two spacers thus obtained, the polystyrene hollow core was fixed on the inside of the stainless steel mold (refer to FIG. 3).

Next, the liquid phenol resin the same as above was poured through the injection hole (or opening) formed on the top of the mold and heated at 70° C. for 20 hours for curing, and then, a curing molded article was released from the mold. Next, a drawing hole with a 5 mm diameter was perforated into the curing molded article, and heated at 200° C. for 10 hours, the molded article being upside down for heating, to cure the core material. By heating, polystyrene forming the core was completely flown out, and the spacers were completely joined with the phenol resin molded article.

The hollow sphere phenol resin molded article thus obtained was put in an electric furnace, and carbonized by heating at 1000° C. for 5 hours under nitrogen atmosphere. As a result, a seamless hollow sphere glasslike carbon molded article having an outer diameter of 25 mm and a thickness of 2 mm without defects such as cracks was obtained.

Although the preferred embodiment of the present invention has been described, it will be understood by those skilled in the art that the present invention should not be limited to the described preferred embodiment, but various changes and modifications can be made within the spirit and scope of the present invention as defined by the appended claims.

What is claimed is:

1. A carbonaceous hollow molded article that is made only of glasslike carbon and having a hollow shape with an expanded central diameter without seams.

2. A fabrication method of the hollow molded article of claim 1, the method comprising:
a cast-molding process for pouring a liquid thermosetting resin into a cavity formed between an outer body and a core made of a thermally fusible (or hot meltable) material, and obtaining a seamless, hollow thermosetting resin molded article having an expanded central diameter;
a core flowing out process, for heating, after the cast-molding process, the thermally fusible material of the cast molded core to make the core melt and flow out; and
a carbonization process for carbonizing the obtained thermosetting resin molded article.

3. The method according to claim 2, wherein a thermally fusible material having a softening point not lower than 70° C. and not higher than 20° C. is used as the core material.

4. The method according to claim 2, wherein, in the cast-molding process, a spacer used to secure the position of the core on the inside of the outer body is made of a thermosetting resin of the same quality as said liquid thermosetting resin, and carbonization is performed with the spacer being incorporated with the cast molded article.

5. The method according to claim 3, wherein, in the cast-molding process, a spacer used to secure the position of the core on the inside of the outer body is preferably made of a thermosetting resin of the same quality as said liquid thermosetting resin, and carbonization is performed with the spacer being incorporated with the cast molded article.
